(19) United States
(12) Patent Application Publication
(10) Pub. No.: US 2026/0073153 A1
(43) Pub. Date: Mar. 12, 2026

(54) CONTEXT-DRIVEN FINE-TUNING FOR RELIABLE RETRIEVAL AUGMENTED GENERATION

(71) Applicant: Oracle International Corporation, Redwood Shores, CA (US)

(72) Inventors: Srikant Panda, Bangalore (IN); Avinash Rajeshchandra Rai, Bengaluru Karnataka (IN); Ming Lin, Bellevue, WA (US)

(21) Appl. No.: 19/002,677

(22) Filed: Dec. 26, 2024

Related U.S. Application Data
(60) Provisional application No. 63/692,103, filed on Sep. 7, 2024.

(51) Int. Cl. G06F 40/40; G06N 20/00

(52) U.S. Cl. CPC G06F 40/40; G06N 20/00

(57) ABSTRACT

Techniques for fine-tuning a machine-learned model for reliable retrieval augmented generation are provided. In one technique, a question for a large language model (LLM) is identified. A context data item that is in an incorrect context relative to the question is also identified. The question and the context data item are input into the LLM, resulting in the LLM generating a response. A training instance that comprises the question, the context data item, a deny response as a correct answer, and the response as a rejected answer is generated. A machine-learned model (e.g., the LLM) is fine-tuned based on the training instance.

### RELATED CASES

This application claims benefit under 35 U.S.C. § 119(e) of provisional application 63/692,103, filed Sep. 7, 2024, by Zheng Wang et al., the entire contents of which is hereby incorporated by reference.

### TECHNICAL FIELD

The present disclosure relates generally to large language models (LLMs) and, more particularly, to automatically generating training data to fine tune LLMs.

### BACKGROUND

Use of large (often pre-trained) language models (LLMs) has become pervasive, underscoring their influential role. However, persistent issues, such as hallucination, reliance on out-of-date information, and the opaqueness of untraceable thought processes continue to pose challenges to more widespread use and acceptance. A prospective remedy to these shortcomings lies in the adoption of Retrieval Augmented Generation (RAG), a system that integrates a retriever component with LLMs.

RAG operates by enhancing the responsiveness of LLMs through the incorporation of real-time data (sourced from external databases) into LLM responses. The design of this process prioritizes user-friendliness, enabling a seamless amalgamation of enriched information into LLM outputs. The synergy achieved between dynamic external resources and the innate knowledge of LLMs plays a pivotal role in significantly elevating response accuracy and believability.

Recent studies indicate that the incorporation of retrieval augmentation may, at times, adversely impact performance. Existing research has identified that the deterioration observed in RAG responses predominantly stems from the noise inherent in the contextual information. For a RAG system to attain optimal functionality, it necessitates precise retrieval accuracy and a meticulously-calibrated LLM response aligned with the context information retrieved. At times, RAG retrieval may fail, leading to having the wrong context for LLM response generation. Thus, it is crucial for a RAG system to exhibit robustness against noise.

Fundamentally, the core challenge revolves around mitigating the persistent issues in LLMs, including incorrect answers, hallucinations, and the inability to decline answering. Many RAG-centric systems heavily rely on prompts to steer LLM responses, a practice that falls short in entirely or significantly minimizing factual errors, such as incorrect answers and hallucinations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section..

### DETAILED DESCRIPTION OF THE DRAWINGS

In the drawings:

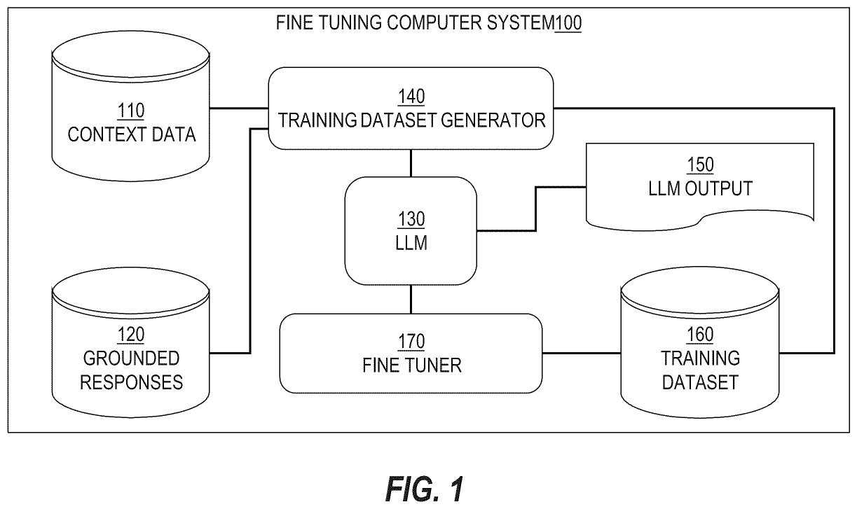

FIG. 1 is a block diagram that depicts an example fine tuning computer system, in an embodiment;

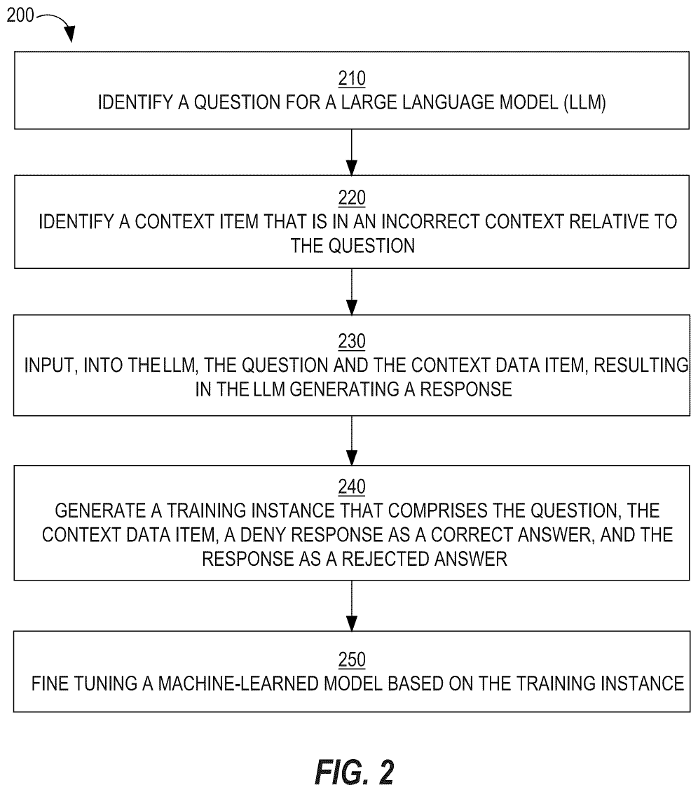

FIG. 2 is a block diagram that depicts an example process for generating a preference training dataset, in an embodiment;

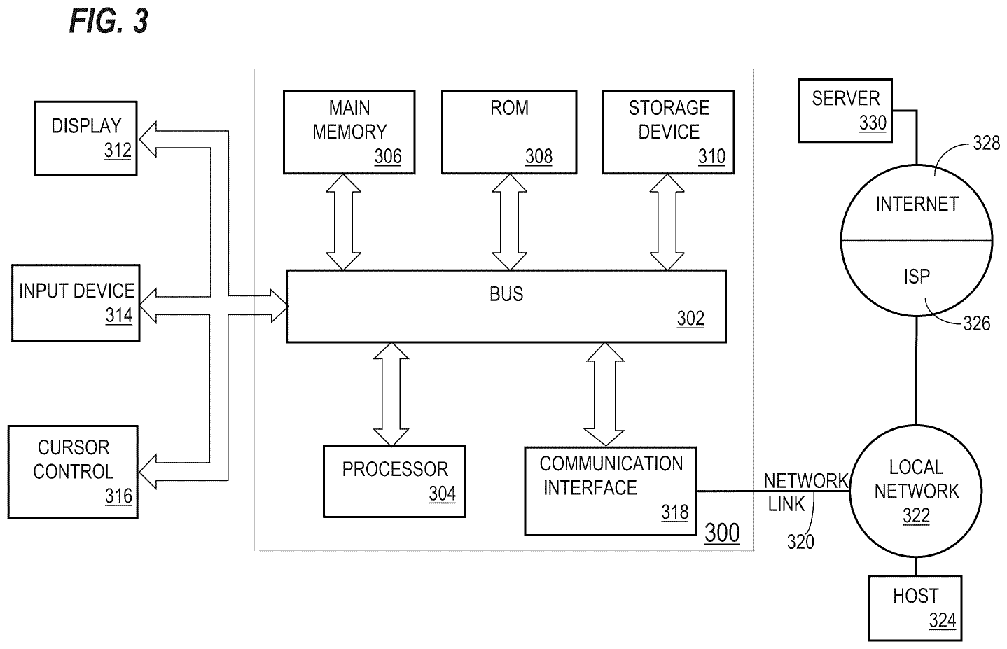

FIG. 3 is a block diagram that illustrates a computer system upon which an embodiment of the invention may be implemented;

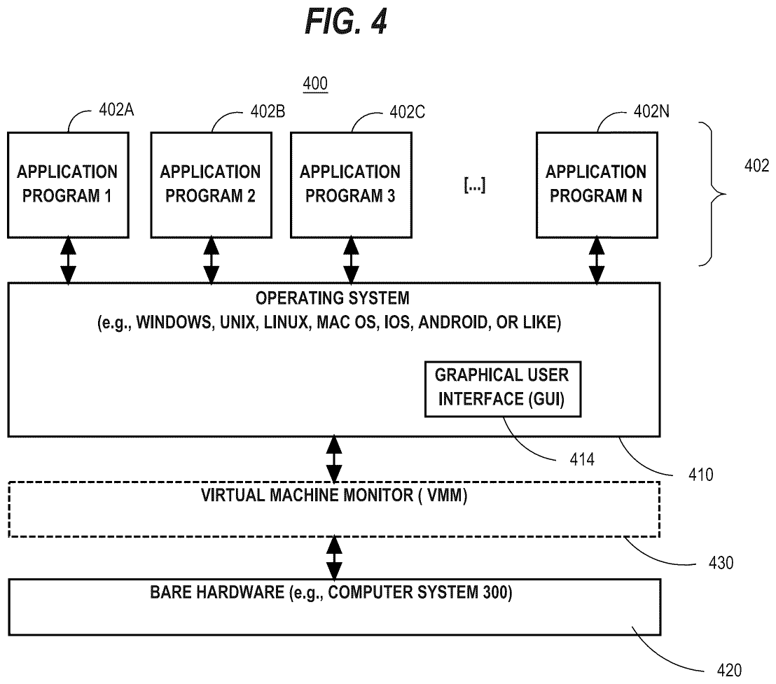

FIG. 4 is a block diagram of a basic software system that may be employed for controlling the operation of the computer system;

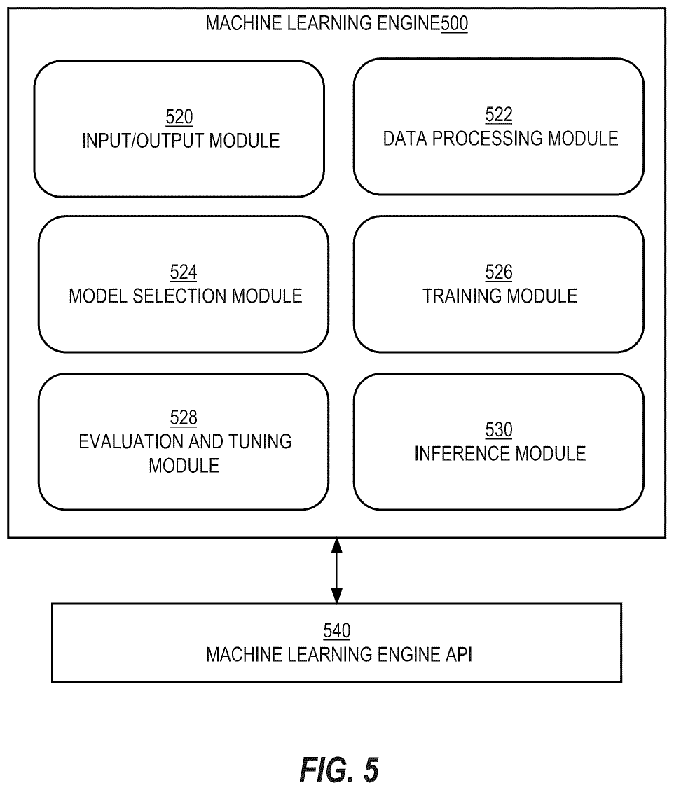

FIG. 5 illustrates a machine learning engine in accordance with one or more embodiments;

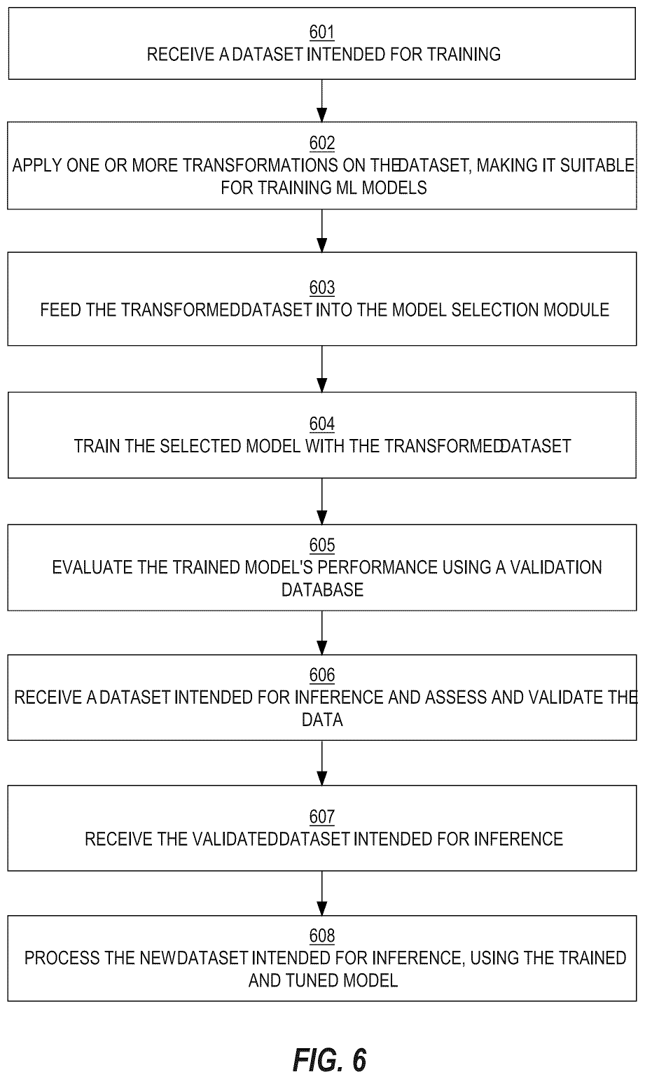

FIG. 6 illustrates the operation of a machine learning engine in one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for fine tuning a large language model (LLM) through strategically leveraging context-dependent training datasets. To address challenges mentioned previously and enhance RAG responses, an alternative method is proposed for fine-tuning language models without the need for human labelling. In one technique, fine-tuning of objectives by utilizing a preference ranking system over potential model responses is implemented. This nuanced approach ensures that the LLM not only draws upon its intrinsic knowledge but also dynamically adjusts its responses based on the real-time data gleaned from external databases. Learning from automatically-generated preference rankings significantly improves the grounding or faithfulness and answer similarity of a known LLM when provided with the correct context. Simultaneously, in scenarios where the LLM encounters incorrect responses, techniques mitigate grounding or faithfulness while concurrently boosting answer similarity by instructing the LLM to abstain from generating a response.

Thus, embodiments assist in noise rejection, meaning that the LLM declines to answer a question when the necessary knowledge is not found in any of the retrieved documents. Here all contextual documents consist solely of noisy content. In such cases, LLMs are anticipated to signal “insufficient information” or employ other rejection signals.

Embodiments also improve computer-related technology related to automatically generating context-dependent training datasets without human labels. Embodiments contribute valuable insights into the practical implications of context-dependent fine-tuning, providing refinement in the development of LLMs. Furthermore, some embodiments involve fine-tuning/aligning an LLM using DPO (or other alignment techniques) using a context-driven preference dataset of consistently superior performance by minimizing the provision of incorrect information. Thus, embodiments improve RAG-reliant LLMs in scenarios where the RAG system retrieves incorrect context for a given prompt. Additionally, through the fine tuning process, (1) the faithfulness of LLM responses in correct contexts is increased while (2) decreases in faithfulness is controlled when the LLM is faced with incorrect contexts. This dual-sided exploration provides a nuanced perspective on the trade-offs involved in fine-tuning for contextual awareness.

### System Overview

FIG. 1 is a block diagram that depicts an example fine tuning computer system 100, in an embodiment. Fine tuning computer system 100 comprises context data 110, grounded responses 120, an LLM 130, training dataset generator 140, LLM output 150, training dataset 160, and fine tuner 170.

Context data 110 comprises a set of context data items, each of which is a candidate context data item for a prompt that is submitted to LLM 130. Examples of context data items include files (e.g., image files, video files, audio files, executable files, source code files) and documents (e.g., text documents, mixed data documents, JSON documents, XML documents, etc.).

In response to a prompt that a user (not depicted) submits (through a computing device) to LLM 130, a RAG system (not depicted) retrieves, from context data 110, a context data item that may be used as input along with the prompt. The RAG system may use one or more selection techniques to select one or more context data items from context data 110.

An example selection technique involves an embedding technique where an embedding is generated for the prompt and is compared to the embedding of each of one or more context data items from context data 110. Each comparison results in a similarity score. The higher the similarity score (indicating a close match or a relevant find), the more likely that the corresponding context data item will be selected as the context data item to accompany the prompt.

Another example selection technique involves N gram matching, an example of which is key word matching. In key word matching, a first set of one or more key words from the prompt is identified and compared with a second set of one or more key words that is associated with a context data item. If there is significant overlap in the two sets of key words, then the context data item may be selected as the context data item to accompany the prompt.

Grounded responses 120 is a set of responses that have been pre-determined to be acceptable responses to corresponding prompts. Each response in grounded response 120 is associated with one or more prompts. Thus, some grounded responses may be associated with multiple prompts, which one or more of which may be variants of another one of the multiple prompts. Grounded responses 120 may be from an existing training data set that has been used to train an existing LLM, such as LLM 130.

LLM 130 is a large language model that may have been trained by the same entity that operates fine tuning computer system 100 or may have been trained by a different entity.

Training dataset generator 140 generates a training dataset that will be used to further train or fine tune LLM 130. For example, training dataset generator 140 leverages context data 110 and LLM 130 to generate LLM output 150, which comprises responses. Based on LLM output 150, training dataset generator 140 classifies (a) some of the responses as correct (in the scenario where the context data item is considered relevant to the prompt and (b) other responses as incorrect (in the scenario where the context data item is considered irrelevant to the prompt). Training dataset generator 140 generates training dataset 160 based on LLM output 150 and based on these classifications, which generation is described in more detail herein.

Fine tuner 170 fine tunes LLM 130 (or a related model) based on training dataset 160 generated by training dataset generator 140. For example, fine tuner 170 implements one or more machine learning techniques, such as Reinforcement Learning (an example of which is Reinforcement Learning from Human Feedback with AI Feedback (RLAIF)), to fine tune a model that is associated with LLM 130. Reinforcement learning (RL) is effective in fine-tuning LLMs by extracting complex behaviors from pretrained weights. In RL, a language model policy, typically an autoregressive Transformer denoted as πθ, generates a conditional distribution πθ(y|x) over responses (y) given an input query (x). The objective of RL is to maximize the average reward for the generated outputs, where a reward function, denoted as r(x, y), assigns a scalar score to input-output pairs based on their desirability.

As another example, fine tuner 170 implements one or more machine learning techniques, such as direct preference optimization (DPO), to fine tune LLM 130. DPO has emerged as a promising alternative to RLAIF for aligning LLMs to human or AI preferences. Unlike traditional alignment methods, which are based on reinforcement learning, DPO recasts the alignment formulation as a simple loss function that can be optimized directly on a dataset or a preference dataset.

RLAIF and DPO are examples of preference learning algorithms. Training dataset 160 that is used to train or fine tune a machine-learned model, such as LLM 130, may be referred to as a preference dataset, where a training instance thereof comprises: (a) a prompt (such as in the form of a question or a command); (b) context (e.g., in the form of one or more documents) that an LLM is to leverage in order to respond to the prompt; (c) a “chosen” response; and (d) a “rejected” response. A chosen response may be an existing response that has already been (e.g., manually) labeled as a good response, or a response that is grounded to the context. A rejected response may be an ungrounded response (which is not based on the context, or any context) or an incorrect response (that is generated based on incorrect context), which does not answer the prompt, either in whole or in part.

To improve model alignment and performance even further, additional DPO variations, such as Knowledge Preference Optimization (KPO), Information Preference Optimization (IPO), and Performance-Reward Preference Optimization (PRPO), Relative Preference Optimization (RPO), Simple Preference Optimization (SimPO), Contrastive Preference Optimization (CPO), and Self-Augmented Preference Optimization may be applied.

### Developing a Context-Driven Training Dataset

In the domain of preference learning algorithms, particularly those exemplified by DPO, the acquisition of preferences regarding potential responses to a given prompt is important for effective and consistent learning. This diverges from conventional emphasis on maximum probability. The following sections introduce an approach to curating a context-driven dataset, eliminating the need for laborious human labeling efforts. The approach involves four main steps: initiating the process, generating ungrounded responses, generating incorrect responses, and providing a deny response.

### Initiating the Process (Step One)

The first step involves a strategic decision on the foundation for the context-driven training dataset. In an embodiment, one or more existing open-source datasets (e.g., the Llama Datasets) are leveraged in order to generate a context-driven training dataset. Open-source datasets may have been designed for benchmarking Retrieval Augmented Generation (RAG) pipelines. Such datasets include question-answer pairs and corresponding context, providing a robust foundation for preference learning.

In a related embodiment, in scenarios where there is a lack of a sufficient number of training instances that comprise question-context-answer tuples, documents containing candidate context data items are identified. Such documents may be unlabeled documents, in which case the documents may be segmented to formulate contextual “chunks,” or individual context data items. For example, a single document may be segmented to generate multiple context data items. Segmentation may involve identifying one or more topics per section and/or per paragraph. Such topic identification may be performed automatically by a topic identifying component (not depicted) and/or a keyword detection component (also not depicted) that analyzes text for keywords. If two consecutive sections/paragraphs are “unrelated” (e.g., less than two topics in common), then the two sections/paragraphs become part of different chunks or context data items.

One or more pre-trained LLMs (e.g., GPT-3.5) are invoked to generate a question-answer pair based on each contextual chunk. For example, training dataset generator 140 generates a prompt that includes (1) a selected contextual chunk and (2) an instruction to an LLM (e.g., LLM 130) to generate a question based on the selected contextual chunk. By invoking the LLM with the prompt, the LLM outputs a question. Training dataset generator 140 associates the question with the contextual chunk. Training dataset generator 140 again invokes the LLM with a second prompt that includes the question and the contextual chunk. The LLM outputs a response. Training dataset generator 140 associates the response (which is presumed to be a grounded response) with the question and the contextual chunk. These three elements (question, contextual chunk, and response) are used to generate a preference training instance, which is added to training dataset 160.

This embodiment of generating a question from a context data item is a versatile strategy that offers flexibility in scenarios where curated datasets may be insufficient.

### Generating Ungrounded Responses (Step Two)

In an embodiment, this step involves generating ungrounded responses by querying (or invoking) an LLM with questions acquired in Step One. Again, the question that is used to query/invoke the LLM may be from an existing dataset or may be a question that an LLM generated given a context data item. In this latter scenario, the LLM that generated the question (in Step One) may be the same as, or different than, the LLM that generates the ungrounded responses (in Step Two). This step establishes a baseline response, which potentially encompasses factual information or erroneous facts based on the pre-training capacity of the LLM.

After generating an ungrounded response, the training dataset generator 140 associates the ungrounded response with the question that was used to invoke the LLM, resulting in the ungrounded response. That question is already associated with a (grounded) answer (determined in Step One) and a context data item (also determined in Step One). Therefore, with this association between the question and the ungrounded response, training dataset generator 140 may (1) generate a training instance that comprises the question, the context data item, the (grounded) answer, and the ungrounded response and (2) add the training instance to training dataset 160.

### Generating Incorrect Responses (Step Three)

In an embodiment, this step aims to simulate scenarios where an LLM is presented with incorrect context and generates a response based thereon, which response is also referred to as an “incorrect response.” Two distinct approaches may be employed to select the incorrect context: an embedding similarity approach and a random context selection approach. Each approach may be performed by training dataset generator 140 or another component of fine tuning computer system 100.

In the embedding similarity approach, the top-k-matched context data items for a question are identified using embedding similarity. For example, an embedding is generated for each context data item, which generation may have occurred before training dataset generator 140 begins Step One. Embedding generation may involve inputting a context data item into an embedding generator, which outputs an embedding for the context data item. The question is also input to the embedding generator, which produces an embedding for the question. Then a similarity score is generated for each pair of embeddings, each pair of embeddings comprising the embedding for the question and an embedding of a different context data item.

A context data item that does not have the highest similarity score is selected to be input to an LLM (e.g., LLM 130) along with the question. For example, the context data item for a question with the lowest similarity score (indicating the least similar) among the similarity scores that are generated based on the question embedding is selected for inputting to an LLM (e.g., LLM 130). As another example, the context data item associated with the lowest similarity score that is above a similarity threshold is selected for inputting to the LLM. As another example, the context data item associated with a highest similarity score that is below a similarity threshold is selected for inputting to the LLM. As another example, the context data item associated with the Nth (e.g., 4^{th}) highest similarity score is selected for inputting to the LLM. In this way, the LLM may be trained with an incorrect response that is based on a semi-relevant context data item and, thus, “learns” to distinguish between “soft” (or easy) negative examples (which are very irrelevant to the corresponding question) and “hard” (or difficult) negative examples, which are relatively close to the correct context of the question. With either or both types of negative context data items, the LLM is challenged to generate an answer based on misleading contextual information.

In a related embodiment, incorrect context is selected based on correct context or on a correct response, presuming that such are available. For example, dissimilar context is identified based on a comparison between embeddings for candidate context data items and an embedding of a correct context data item or an embedding of a correct response.

In the random context selection approach, an arbitrary context for a given question is randomly selected and the LLM is prompted to generate an answer based on the selected context. Such an approach further tests the LLM's robustness against ambiguous or irrelevant information.

In a related embodiment, incorrect context is selected based on n-gram matching. For example, there are ten candidate context data items and one of those ten does not match any n-gram. That one candidate context data item may be selected as a negative context data item.

### Providing a Deny Response (Step Four)

The fourth type of response involves the LLM explicitly denying an answer when the provided context cannot adequately address the given query. This step emphasizes the importance of the LLM's ability to recognize limitations and abstain from generating potentially misleading or incorrect responses. Examples of a deny response include the following text: “Insufficient data is available to answer your question” and “Regrettably, the available context is insufficient to provide a comprehensive answer to your question.” The deny response may explicitly indicate that there does not exist relevant context for the question in the prompt.

In a related embodiment, the deny response indicates that the user has the option to receive a response from the LLM even though the provided context is inaccurate or incorrect. For example, the option may come in the form of a button that is presented to the user along with the deny response. User selection of the button resubmits the question to the LLM. The associated RAG system may retrieve another context data item or the LLM may leverage the already-retrieved context without the RAG system performing another retrieval operation for the resubmitted question.

### Components of a Training Instance

In an embodiment, a training instance that is used to fine-tune an LLM (or an associated model, in the case of RL) comprises four main parts or components that training dataset generator 140 assembles: (1) the prompt, (2) the context, (3) a chosen answer, and (4) a rejected answer.

The prompt comprises a question or command with a system prompt or instructions. The following is an example prompt that comprises a task (or system prompt/instructions), a question, and context:
Task:
   You are required to generate a response to the given question by utilizing the provided document text. The response should be well-supported by the context and address the question comprehensively.
Question:
   What are the benefits of regular physical exercise?
Context:
   Regular physical exercise has been shown to offer numerous benefits, including enhanced physical fitness, improved cardiovascular health, and increased muscular strength. Additionally, it plays a key role in boosting mental well-being, reducing stress, and improving cognitive function. As part of a comprehensive wellness routine, exercise can enhance both physical and psychological resilience, fostering long-term health and well-being.

The prompt may be the same or different in both the correct context and the incorrect context scenarios

Sometimes, the prompt is considered to include the context; however, the context is described herein as separate from the prompt. The context can either be the correct context for the question or an incorrect context for the question, such as the incorrect context that is selected using one of the approaches in Step Three.

Regarding the chosen answer (3), in scenarios where the prompt contains the correct context, the chosen answer is generated from Step One. Conversely, if the prompt contains incorrect context, then the chosen answer is a denial response (Step Four), signaling the LLM's recognition of the inability to answer. In other words, the correct answer to provide in scenarios where the context is incorrect or inaccurate is to inform the user that submitted the prompt that a response that attempts to answer the question will not be provided.

Regarding the rejected answer (4), for correct contexts, the rejected answer may be an ungrounded response (from Step Two) or an incorrect answer (from Step Three) that was generated using a random context or a hard/soft negative context. For negative or incorrect contexts, the rejected answer is from Step Three, representing an incorrect answer using a random context or a hard/soft negative context.

A single prompt (i.e., question/command) may be part of multiple preference training instances. For example, a question/command may be part of: (i) a first training instance where the context is correct and the rejected answer is an ungrounded response; (ii) a second training instance where the context is correct and the rejected answer is an incorrect answer; and (iii) a third training instance where the context is incorrect.

Construction of the preference training dataset in this manner ensures alignment of the LLM's behavior under various contextual scenarios, laying the groundwork for an improved and contextually-aware fine-tuning process.

With a training dataset generated one or more training instances having this format (i.e., prompt, context, chosen answer, and rejected answer), the training dataset may be used to train an LLM (e.g., LLM 130) (such as in the case of DPO) or a model that is associated with the LLM, such as in the case of RLAIF.

### Training Instance Selection

In an embodiment, fine tuner 170 selects a subset of training dataset 160 based on a pre-determined value for each of one or more types of training instances. Thus, fine tuner 170 might not select all training instances that are in training dataset 160, at least in one fine tuning operation, which may involve multiple training instances.

The three types of training instances are (1) correct context and the rejected answer is an ungrounded response, (2) correct context and the rejected answer is an incorrect context (i.e., based on incorrect context), and (3) incorrect context. The pre-determined value may be a default value or a user-specified value. The pre-determined value may be a percentage value or a positive integer.

For example, 35% of training instances that fine tuner 170 selects are of type (1), 40% of training instances that fine tuner 170 selects are of type (2), and 25% of training instances that fine tuner 170 selects are of type (3). As another example, fine tuner 170 selects one hundred training instances that are of type (1), two hundred training instances that are of type (2), and two hundred and fifty training instances that are of type (3).

In response to a determination to perform a fine tuning operation of LLM 130 that involves multiple training instances, fine tuner 170 may select, from training dataset 160, training instances that do not have any prompts (or questions) in common. Alternatively, fine tuner 170 may ensure that for each prompt, at least two training instances that contain that prompt are selected from training dataset 160.

### Example Process

FIG. 2 is a block diagram that depicts an example process 200 for generating a preference training dataset, in an embodiment. Process 200 may be performed by one or more components of fine tuning computer system 100, such as training data set generator 140.

At block 210, a question is identified for a large language model (LLM). The first question may be identified in a pre-existing training dataset that may have been used to train the LLM or another LLM. Thus, the first question may be stored in a database of questions that have been manually curated. Alternatively, the first question may have been automatically generated by a second LLM (which may be the same or different LLM than the LLM that is being fine-tuned). In this latter scenario, the second LLM is prompted to generate a question given a particular context data item as input.

At block 220, a context data item that is in an incorrect context relative to the first question is identified. Block 220 may involve a random selection of the context data item among a set of context data items. Alternatively, block 220 may involve generating a similarity score between each candidate context data item and the question (using their respective embeddings) and then selecting a context data item that does not have the highest similarity score, such as selecting the context data item with the highest similarity score the is below a score threshold or selecting the context data item with the third highest similarity score.

At block 230, the question and the context data item are input into by the LLM, resulting in the LLM generating a response, referred to as an “incorrect response” because it is generated based on incorrect context.

At block 240, a training instance is generated that comprises the question, the context data item, a deny response as a correct answer, and the incorrect response as a rejected answer. Block 240 may involve assembling these four components into a single text record that identifies each component (e.g., “Question,” “Incorrect Context,” “Correct Answer,” and “Rejected Answer”) and includes the corresponding value of each component.

At block 250, a machine-learned model is fine-tuned based on the training instance. The machine-learned model may be the LLM or a model that is associated with the LLM, such as in the RLAIF scenario.

Process 200 may repeat for each question of multiple candidate questions. Also, block 250 may be delayed until a threshold number of training instances are generated using blocks 210-240. For example, the machine-learned model may be fine-tuned only after twenty training instances are automatically generated using twenty iterations of blocks 210-240.

In a related embodiment, process 200 is repeated but instead of identifying incorrect context for a second question, a “correct” context data item for the second question is identified. Such correct context may have been pre-associated with the second question. If the second question is the same as the question in block 210, then the related process may involve reading a second context data item from the same record or data structure as the “incorrect” context data item. Alternatively, the correct context data item may have been selected first and then an LLM is invoked with the correct context data item to generate the question.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

FIG. 4 is a block diagram of a basic software system 400 that may be employed for controlling the operation of computer system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computer system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

### Machine Learning Architecture

FIG. 5 illustrates a machine learning engine 500 in accordance with one or more embodiments. As illustrated in FIG. 5, machine learning engine 500 includes input/output module 520, data preprocessing module 522, model selection module 524, training module 526, evaluation and tuning module 528, and inference module 530.

In accordance with an embodiment, input/output module 520 serves as the primary interface for data entering and exiting the system, managing the flow and integrity of data. This module may accommodate a wide range of data sources and formats to facilitate integration and communication within the machine learning architecture.

In an embodiment, an input handler within input/output module 520 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 520 to be versatile in different operational contexts, whether processing historical datasets or streaming data.

In accordance with an embodiment, input/output module 520 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 520 includes an output framework designed to handle the distribution and exportation of outputs, predictions, or insights. Using the output framework, input/output module 520 formats these outputs into user-friendly and accessible formats, such as reports, visualizations, or data files compatible with other systems. Input/output module 520 also ensures secure and efficient transmission of these outputs to end-users or other systems in an embodiment and may employ encryption and secure data transfer protocols to maintain data confidentiality.

In accordance with an embodiment, data preprocessing module 522 transforms data into a format suitable for use by other modules in machine learning engine 500. For example, data preprocessing module 522 may transform raw data into a normalized or standardized format suitable for training ML models and for processing new data inputs for inference. In an embodiment, data preprocessing module 522 acts as a bridge between the raw data sources and the analytical capabilities of machine learning engine 500.

In an embodiment, data preprocessing module 522 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 522 may be configured to handle anomalies in different ways depending on context. Data preprocessing module 522 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 522 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 522 processes new data for inference, data preprocessing module 522 replicates the same preprocessing steps to ensure consistency with the training data format. This helps to avoid discrepancies between the training data format and the inference data format, thereby reducing the likelihood of inaccurate or invalid model predictions.

In an embodiment, model selection module 524 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 524 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 524 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 524 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 524 also considers computational efficiency and resource constraints. This is meant to help ensure the selected model is both accurate and practical in terms of computational and time requirements. In an embodiment, certain features of model selection module 524 are configurable such as a configured bias toward (or against) computational efficiency.

In accordance with an embodiment, training module 526 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 526 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 526 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 526 includes logic to handle different types of data and learning tasks. For instance, it includes different training routines for supervised learning (where the training data comes with labels) and unsupervised learning (without labeled data). In the case of deep learning models, training module 526 also manages the complexities of training neural networks that include initializing network weights, choosing activation functions, and setting up neural network layers.

In an embodiment, evaluation and tuning module 528 incorporates dynamic feedback mechanisms and facilitates continuous model evolution to help ensure the system's relevance and accuracy as the data landscape changes. Evaluation and tuning module 528 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 528 performs continuous model tuning by using hyperparameter optimization. Evaluation and tuning module 528 performs an exploration of the hyperparameter space using algorithms, such as grid search, random search, or more sophisticated methods like Bayesian optimization. Evaluation and tuning module 528 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 528 integrates data feedback and updates the model. Evaluation and tuning module 528 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 528 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 528 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 530 transforms data raw data into actionable, precise, and contextually relevant predictions. In addition to processing and applying a trained model to new data, inference module 530 may also include post-processing logic that refines the raw outputs of the model into meaningful insights.

In an embodiment, inference module 530 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 530 transforms the outputs of a trained model into definitive classifications. Inference module 530 employs the underlying model as a tool to generate probabilistic outputs for each potential class. It then engages in an interpretative process to convert these probabilities into concrete class labels.

In an embodiment, when inference module 530 receives the probabilistic outputs from the model, it analyzes these probabilities to determine how they are distributed across some or every potential class. If the highest probability is not significantly greater than the others, inference module 530 may determine that there is ambiguity or interpret this as a lack of confidence displayed by the model.

In an embodiment, inference module 530 uses thresholding techniques for applications where making a definitive decision based on the highest probability might not suffice due to the critical nature of the decision. In such cases, inference module 530 assesses if the highest probability surpasses a certain confidence threshold that is predetermined based on the specific requirements of the application. If the probabilities do not meet this threshold, inference module 530 may flag the result as uncertain or defer the decision to a human expert. Inference module 530 dynamically adjusts the decision thresholds based on the sensitivity and specificity requirements of the application, subject to calibration for balancing the trade-offs between false positives and false negatives.

In accordance with an embodiment, inference module 530 contextualizes the probability distribution against the backdrop of the specific application. This involves a comparative analysis, especially in instances where multiple classes have similar probability scores, to deduce the most plausible classification. In an embodiment, inference module 530 may incorporate additional decision-making rules or contextual information to guide this analysis, ensuring that the classification aligns with the practical and contextual nuances of the application.

In regression models, where the outputs are continuous values, inference module 530 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 530 incorporates domain-specific adjustments into its post-processing routine. This involves tailoring the model's output to align with specific industry knowledge or contextual information. For example, in financial forecasting, inference module 530 may adjust predictions based on current market trends, economic indicators, or recent significant events, ensuring that the outputs are both statistically accurate and practically relevant.

In an embodiment, inference module 530 includes logic to handle uncertainty and ambiguity in the model's predictions. In cases where inference module 530 outputs a measure of uncertainty, such as in Bayesian inference models, inference module 530 interprets these uncertainty measures by converting probabilistic distributions or confidence intervals into a format that can be easily understood and acted upon. This provides users with both a prediction and an insight into the confidence level of that prediction. In an embodiment, inference module 530 includes mechanisms for involving human oversight or integrating the instance into a feedback loop for subsequent analysis and model refinement.

In an embodiment, inference module 530 formats the final predictions for end-user consumption. Predictions are converted into visualizations, user-friendly reports, or interactive interfaces. In some systems, like recommendation engines, inference module 530 also integrates feedback mechanisms, where user responses to the predictions are used to continually refine and improve the model, creating a dynamic, self-improving system.

FIG. 6 illustrates the operation of a machine learning engine in one or more embodiments. In an embodiment, input/output module 520 receives a dataset intended for training (Operation 601). This data can originate from diverse sources, like databases or real-time data streams, and in varied formats, such as CSV, JSON, or XML. Input/output module 520 assesses and validates the data, ensuring its integrity by checking for consistency, data ranges, and types.

In an embodiment, training data is passed to data preprocessing module 522. Here, the data undergoes a series of transformations to standardize and clean it, making it suitable for training ML models (Operation 602). This involves normalizing numerical data, encoding categorical variables, and handling missing values through techniques like imputation.

In an embodiment, prepared data from the data preprocessing module 522 is then fed into model selection module 524 (Operation 603). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 526 trains the selected model with the prepared dataset (Operation 604). It implements learning algorithms to adjust the model's internal parameters, optimizing them to identify patterns and relationships in the training data. Training module 526 also addresses the challenge of overfitting by implementing techniques, like regularization and early stopping, ensuring the model's generalizability.

In an embodiment, evaluation and tuning module 528 evaluates the trained model's performance using the validation dataset (Operation 605). Evaluation and tuning module 528 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 520 receives a dataset intended for inference. Input/output module 520 assesses and validates the data (Operation 606).

In an embodiment, data preprocessing module 522 receives the validated dataset intended for inference (Operation 607). Data preprocessing module 522 ensures that the data format used in training is replicated for the new inference data, maintaining consistency and accuracy for the model's predictions.

In an embodiment, inference module 530 processes the new data set intended for inference, using the trained and tuned model (Operation 608). It applies the model to this data, generating raw probabilistic outputs for predictions. Inference module 530 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 540 allows for applications to leverage machine learning engine 500. In an embodiment, machine learning engine API 540 may be built on a RESTful architecture and offer stateless interactions over standard HTTP/HTTPS protocols. Machine learning engine API 540 may feature a variety of endpoints, each tailored to a specific function within machine learning engine 500. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 540 is equipped to support SOAP-based interactions. This extension involves defining a WSDL (Web Services Description Language) document that outlines the API's operations and the structure of request and response messages. In an embodiment, machine learning engine API 540 supports various data formats and communication styles. In an embodiment, machine learning engine API 540 endpoints may handle requests in JSON format or any other suitable format. For example, machine learning engine API 540 may process XML, and it may also be engineered to handle more compact and efficient data formats, such as Protocol Buffers or Avro, for use in bandwidth-limited scenarios.

In an embodiment, machine learning engine API 540 is designed to integrate WebSocket technology for applications necessitating real-time data processing and immediate feedback. This integration enables a continuous, bi-directional communication channel for a dynamic and interactive data exchange between the application and machine learning engine 500.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 520, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 522 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 524, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 526, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 528 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 530, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a question for a large language model (LLM);
identifying a context data item that is in an incorrect context relative to the question;
inputting, into by the LLM, the question and the context data item, resulting in the LLM generating a response;
generating a training instance that comprises the question, the context data item, a deny response as a correct answer, and the response as a rejected answer;
fine tuning a machine-learned model based on the training instance;
wherein the method is performed by one or more computing devices.

2. The method of claim 1, further comprising:
for each context data item of a plurality of context data items:
generating a similarity score between said each context data item and (i) the question or (ii) a known response for the question;
adding the similarity score to a set of similarity scores;
selecting a particular similarity score from the set of similarity scores, wherein the particular similarity score is not the highest similarity score in the set of similarity scores;
wherein identifying the context data item comprises identifying the context data item based on the particular similarity score.

3. The method of claim 2, wherein selecting the particular similarity score comprises selecting the highest similarity score that is less than a similarity threshold, wherein the set of similarity scores includes one or more similarity scores that are higher than the similarity threshold.

4. The method of claim 2, wherein generating the similarity score comprises:
generating the similarity score between an embedding of said each context data item and an embedding of the question or an embedding of the known response; or
using n-gram matching technique to generate the similarity score between said each context data item and (i) the question or (ii) the known response for the question.

5. The method of claim 1, further comprising:
storing a plurality of context data items that includes the context data item;
wherein identifying the context data item comprises randomly selecting the context data item from the plurality of context data items.

6. The method of claim 1, further comprising, prior to identifying the question:
identifying a second context data item for the question;
inputting, into a second LLM, the second context data item and a prompt that instructs the second LLM to generate a question that the second context data item answers;
in response to inputting the second context data item and the prompt into the second LLM, generating, by the second LLM, the question.

7. The method of claim 1, further comprising:
identifying a second question for the LLM;
identifying a second context data item for the second question;
identifying a second response that is based on the second question and the second context data item;
generating, based on the second question and without any context data item, by the LLM, a third response;
generating a second training instance that comprises the second question, the second context data item, the second response as a correct answer, and the third response as a rejected answer;
fine tuning the machine-learned model based on the second training instance.

8. The method of claim 7, wherein the second question is the question.

9. The method of claim 1, further comprising:
identifying a second question for the LLM;
identifying a second context data item for the second question;
identifying a second response that is based on the second question and the second context data item;
identifying a third context data item that is in an incorrect context relative to the second question;
inputting, into by the LLM, the second question and the third context data item, resulting in the LLM generating a third response;
generating a second training instance that comprises the second question, the second context data item, the second response as a correct answer, and the third response as a rejected answer;
fine tuning the machine-learned model based on the second training instance.

10. The method of claim 1, wherein the second question is the question and the third context data item is the context data item.

11. The method of claim 1, wherein:
the machine-learned model is the LLM;
fine tuning comprises using direct preference optimization (DPO) to fine tune the LLM.

12. A method comprising:
identifying a question for a large language model (LLM);
identifying a context data item for the first question;
identifying a response that is based on the question and the context data item;
inputting, into by the LLM, the question and the context data item, resulting in the LLM generating a first response;
generating, by the LLM, based on the question and without the context data item, a second response;
generating a training instance that comprises the question, the context data item, the first response as a correct answer, and the second response as a rejected answer;
fine tuning a machine-learned model based on the training instance;
wherein the method is performed by one or more computing devices.

13. The method of claim 12, wherein the second response is not based on any context data item accompanying the question as input to the LLM.

14. The method of claim 12, further comprising:
selecting a second context data item that is in an incorrect context relative to the question;
wherein generating the second response comprises inputting the second context data item into the LLM with the question;
wherein the second response is also based on the second context data item.

15. One or more non-transitory storage media storing instructions which, when executed by one or more computing devices, cause:
identifying a question for a large language model (LLM);
identifying a context data item that is in an incorrect context relative to the question;
inputting, into by the LLM, the question and the context data item, resulting in the LLM generating a response;
generating a training instance that comprises the question, the context data item, a deny response as a correct answer, and the response as a rejected answer;
fine tuning a machine-learned model based on the training instance;
wherein the method is performed by one or more computing devices.

16. The one or more storage media of claim 15, wherein the instructions, when executed by one or more computing devices, further cause:
for each context data item of a plurality of context data items:
generating a similarity score between said each context data item and (i) the question or (ii) a known response for the question;
adding the similarity score to a set of similarity scores;
selecting a particular similarity score from the set of similarity scores, wherein the particular similarity score is not the highest similarity score in the set of similarity scores;
wherein identifying the context data item comprises identifying the context data item based on the particular similarity score.

17. The one or more storage media of claim 15, wherein the instructions, when executed by one or more computing devices, further cause:
storing a plurality of context data items that includes the context data item;
wherein identifying the context data item comprises randomly selecting the context data item from the plurality of context data items.

18. The one or more storage media of claim 15, wherein the instructions, when executed by one or more computing devices, further cause, prior to identifying the question:
identifying a second context data item for the question;
inputting, into a second LLM, the second context data item and a prompt that instructs the second LLM to generate a question that the second context data item answers;
in response to inputting the second context data item and the prompt into the second LLM, generating, by the second LLM, the question.

19. The one or more storage media of claim 15, wherein the instructions, when executed by one or more computing devices, further cause:
identifying a second question for the LLM;
identifying a second context data item for the second question;
identifying a second response that is based on the second question and the second context data item;
generating, based on the second question and without any context data item, by the LLM, a third response;
generating a second training instance that comprises the second question, the second context data item, the second response as a correct answer, and the third response as a rejected answer;
fine tuning the machine-learned model based on the second training instance.

20. The one or more storage media of claim 15, wherein:
the machine-learned model is the LLM;
fine tuning comprises using direct preference optimization (DPO) to fine tune the LLM.
